(19) United States
(12) Patent Application Publication
(10) Pub. No.: US 2021/0303842 A1
(43) Pub. Date: Sep. 30, 2021

(54) INFORMATION PROCESSING DEVICE AND NON-TRANSITORY COMPUTER READABLE MEDIUM

(71) Applicant: FUJIFILM Business Innovation Corp., Tokyo (JP)

(72) Inventors: Shintaro ADACHI, Kanagawa (JP); Shusaku KUBO, Kanagawa (JP); Shigeru OKADA, Kanagawa (JP); Kunihiko KOBAYASHI, Kanagawa (JP); Yusuke SUZUKI, Kanagawa (JP)

(73) Assignee: FUJIFILM Business Innovation Corp., Tokyo (JP)

(21) Appl. No.: 16/931,357

(22) Filed: Jul. 16, 2020

(30) Foreign Application Priority Data
Mar. 26, 2020 (JP) 2020-055528

(51) Int. Cl. G06K 9/00; G06K 9/20; G06K 9/46

(52) U.S. Cl. CPC G06K 9/00463; G06K 9/2054; G06K 2209/01; G06K 2209/21; G06K 9/4604

(57) ABSTRACT

An information processing device is provided with a processor configured to acquire a document image illustrating a document, and extract target information with respect to a target character string from a region set with reference to a position of a specific type of impression included in the document image.

### CROSS-REFERENCE TO RELATED APPLICATIONS

This application is based on and claims priority under 35 USC 119 from Japanese Patent Application No. 2020-055528 filed Mar. 26, 2020.

### BACKGROUND

### (i) Technical Field

The present disclosure relates to an information processing device and a non-transitory computer readable medium.

### (ii) Related Art

Technology that extracts desired information from a document image illustrating a document is known. For example, Japanese Unexamined Patent Application Publication No. 2004-178044 describes performing morphological analysis on character fields of a document, comparing the morphological analysis result with document attribute part-of-speech patterns that express the structure of document attributes as morphological levels, and from among the matching character fields, extracting a character field whose appearance position in the document is in a predetermined range as a document attribute.

### SUMMARY

In some cases, it is desirable to extract information such as the names of the parties to a contract from a document such as a contract. However, in the case where a document contains names other than the parties to the contract, such as company names for example, the names other than the parties to the contract may be extracted with a method that analyzes text to distinguish target information.

Aspects of non-limiting embodiments of the present disclosure relate to extracting target information more accurately compared to the case of extracting target information from a target character string irrespectively of the position of a specific type of impression.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing device provided with a processor configured to acquire a document image illustrating a document, and extract target information with respect to a target character string from a region set with reference to a position of a specific type of impression included in the document image.

### BRIEF DESCRIPTION OF THE DRAWINGS

An exemplary embodiment of the present disclosure will be described in detail based on the following figures, wherein:

FIG. 1 is a diagram illustrating an example of the configuration of an image processing device 10 according to an exemplary embodiment;

FIG. 2 is a diagram illustrating an example of a document image;

FIG. 3 is a flowchart illustrating an example of a process of extracting a value corresponding to a key from a document image;

FIG. 4 is a flowchart illustrating an example of a company seal determination process;

FIG. 5 is a flowchart illustrating an example of a tally seal determination process;

FIG. 6 is a diagram illustrating an example of a different document image; and

FIG. 7 is a flowchart illustrating an example of a revision seal determination process.

### DETAILED DESCRIPTION

### 1. Configuration

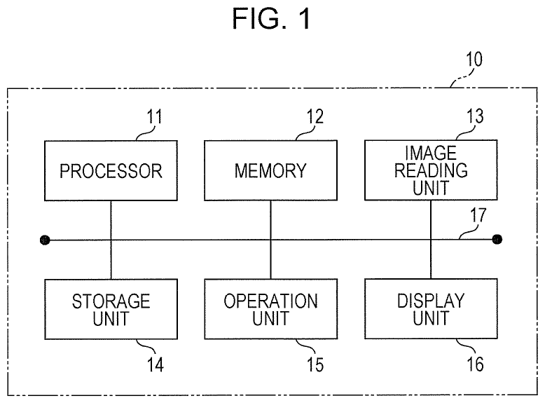

FIG. 1 is a diagram illustrating an example of the configuration of an image processing device 10 according to an exemplary embodiment. The image processing device 10 is one example of an information processing device according to an exemplary embodiment of the present disclosure. The image processing device 10 has a scan function, and reads a document such as a contract to acquire a document image. Also, the image processing device 10 has a character recognition function, and extracts a value on the basis of a key included in the document image. The key is a character string that serves as a marker of the value. The key may include at least one of a character, a numeral, a symbol, and an image. The key is an example of a “target character string” according to an exemplary embodiment of the present disclosure. The value is information desired by a user. The value may include at least one of a character, a numeral, a symbol, and an image. The value is an example of “target information” according to an exemplary embodiment of the present disclosure. Note that it is assumed that the “character string” referred to herein may include not only characters, but also numerals and symbols. The value extracted from the document image is used in various processes. For example, the value extracted from the document image may be used in a file name or a folder name of the document image, or may be transmitted to a destination prescribed for the value.

The image processing device 10 is provided with a processor 11, memory 12, an image reading unit 13, a storage unit 14, an operation unit 15, and a display unit 16. These hardware elements are connected through a bus 17. By executing a program, the processor 11 controls each unit of the image processing device 10 and performs a process of extracting a value corresponding to a key from the document image. For the processor 11, a central processing unit (CPU) is used for example. The memory 12 stores a program for causing the processor 11 to execute the process described above. For the memory 12, read-only memory (ROM) and random access memory (RAM) are used for example. The image reading unit 13 reads a document to generate a document image. For the image reading unit 13, an image scanner is used for example. The storage unit 14 stores the document image generated by the image reading unit 13. For the storage unit 14, a hard disk drive or a solid-state drive (SSD) is used for example. The operation unit 15 is used by the user to operate the image processing device 10. For the operation unit 15, a touch panel and one or more buttons are used for example. The display unit 16 displays various screens that the user uses to perform operations. For the display unit 16, a liquid crystal display is used for example.

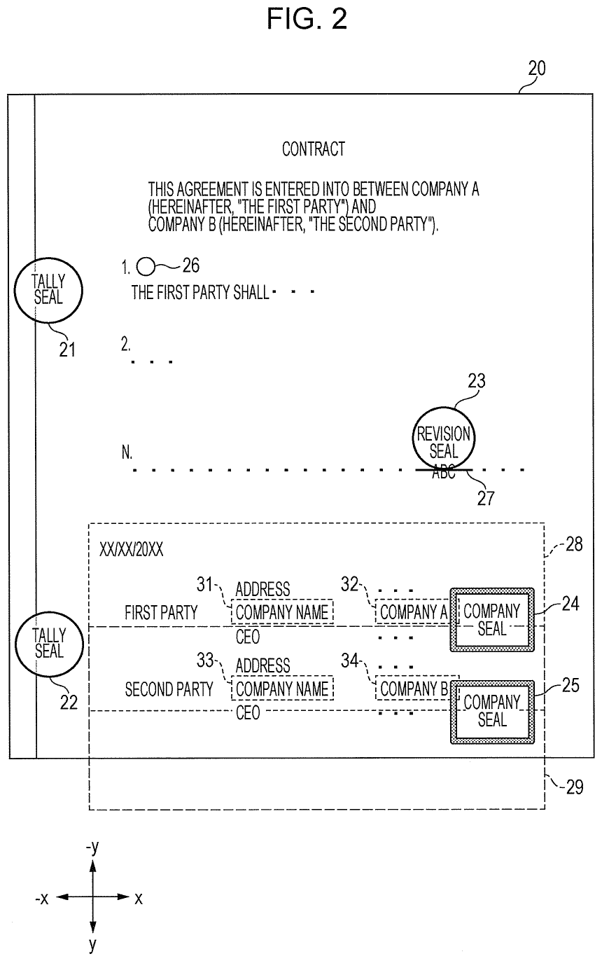

FIG. 2 is a diagram illustrating an example of a document image 20. Note that the x axis direction and the y axis direction illustrated in FIG. 2 represent mutually orthogonal directions. Also, the −x axis direction and the −y axis direction represent the opposite directions of the x axis direction and the y axis direction, respectively. The document image 20 illustrated in FIG. 2 is an image illustrating a contract. The contract may also include multiple pages. Here, the value is assumed to be information indicating a party to the contract. In the example illustrated in FIG. 2, the key is “company name”, and the value is the company name of the first party and the company name of the second party to the contract.

In a signature field at the end of the contract, a character string 31 stating “Company Name” is arranged beside a character string 32 stating “Company A” indicating the company name of the first party to the contract, while a character string 33 stating “Company Name” is arranged beside a character string 34 stating “Company B” indicating the company name of the second party to the contract. Generally, in the case where a party to a contract is a company, a company seal is impressed at a position overlapping the last character of the company name. A company seal refers to a seal used by a company. Generally, a company seal has a square shape, and the impression of a company seal is larger than the impressions of other types of seals. Also, generally, the signature field at the end of a contract where a company seal is impressed has more whitespace than other portions of the contract. In the example illustrated in FIG. 2, the company seal of the first party is impressed at a position overlapping the last character of the character string 32 stating “Company A”. Consequently, the document image 20 is provided with an impression 24 of the company seal of the first party at a position overlapping the last character of the character string 32 stating “Company A”. Similarly, the company seal of the second party is impressed at a position overlapping the last character of the character string 34 stating “Company B”. Consequently, the document image 20 is provided with an impression 25 of the company seal of the second party at a position overlapping the last character of the character string 34 stating “Company B”. The impressions 24 and 25 are examples of a specific type of impression according to an exemplary embodiment of the present disclosure.

Also, in some cases, seals other than a company seal, such as a tally seal and a revision seal, may be impressed on a contract. A tally seal refers to a seal in the case where the contract is two or more pages, with the seal being impressed to straddle the two pages and thereby indicate that the multiple pages are related to each other. Generally, a tally seal is impressed at an interval from a predetermined position of the document. For example, on a spread layout containing two pages arranged side by side, the positions where the tally seals are impressed are in the central part at the boundary between the side-by-side pages. On the other hand, on single pages not in a spread layout, the positions where the tally seals are impressed are along the edge of the pages. Note that tally seals may be impressed at equally spaced intervals. In the example illustrated in FIG. 2, the contract contains single pages, and therefore two tally seals are impressed at an interval from the edge in the −x axis direction. Consequently, impressions 21 and 22 of the two tally seals are provided at an interval from the edge in the −x axis direction of the document image 20. The impressions 21 and 22 of the tally seals are an example of a first type of impression according to an exemplary embodiment of the present disclosure.

A revision seal refers to a seal that is impressed to clearly indicate that someone has made a revision when revising a portion of a document. Generally, in the case of correcting incorrect characters, strikethrough is applied to the corrected portion, and a revision seal is impressed at a position corresponding to the corrected portion. The strikethrough may be a single line or double lines. In the example illustrated in FIG. 2, in the document image 20, a strikethrough line 27 is applied to the characters “ABC” stated in the contract, and a revision seal is impressed near the characters. Consequently, the document image 20 is provided with an impression 23 of the revision seal near the characters marked by the strikethrough line 27. The impression 23 of the revision seal is an example of a second type of impression according to an exemplary embodiment of the present disclosure.

### 2. Operations

In the following description, the case where the processor 11 is described as the agent of the processes means that the processes are performed by the processor 11 performing calculations or controlling the operations of other hardware elements through cooperation between the program stored in the memory 12 and the processor 11 executing the program.

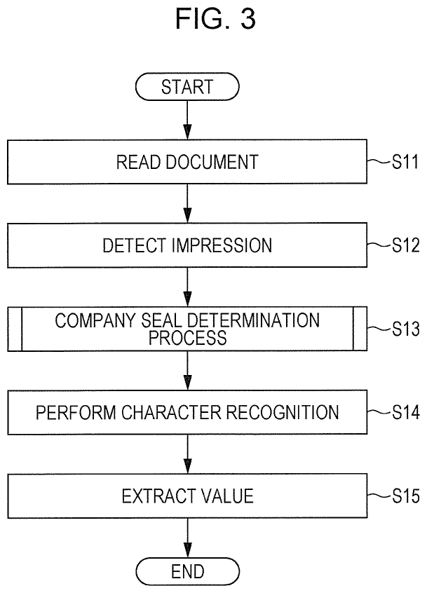

FIG. 3 is a flowchart illustrating an example of a process of extracting a value corresponding to a key from a document image. The process is started in response to, for example, the user setting a document in the image processing device 10 and using the operation unit 15 to perform an instruction operation to start reading the document. Also, at this time, the user uses the operation unit 15 to perform an operation of designating a number of values to extract. In the example illustrated in FIG. 2, because there are two parties to the contract, and the information indicating the parties to the contract is the company name of the first party and the company name of the second party, the number of values to extract is 2.

In step S11, the processor 11 causes the image reading unit 13 to read a document according to an operation by the user. With this arrangement, a document image illustrating the document is acquired. In the example illustrated in FIG. 2, the contract is read, and the document image 20 illustrating the contract is acquired.

In step S12, the processor 11 detects impressions from the document image. The detection of impressions is performed using existing impression detection technology, for example. For example, a vermilion portion approximately the size of an impression in the document image may be detected as an impression. In the example illustrated in FIG. 2, the impressions 21 to 25 and a noise image 26 are detected from the document image 20. The noise image 26 is not actually an impression, but is detected as an impression because the noise image 26 is a vermilion portion approximately the size of an impression.

In step S13, the processor 11 performs a company seal determination process. As illustrated in FIG. 2, besides the impressions 24 and 25 of the company seals, the document image 20 also includes the impressions 21 and 22 of the tally seals, the impression 23 of the revision seal, and the noise image 26. For this reason, the company seal determination process is performed to determine the impressions 24 and 25 of the company seals from among the impressions detected in step S12.

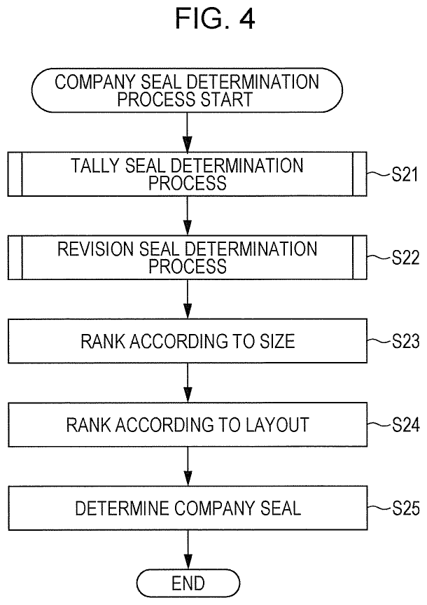

FIG. 4 is a flowchart illustrating an example of a company seal determination process. In step S21, the processor 11 performs a tally seal determination process. The tally seal determination process is performed on each impression detected in step S12. In the tally seal determination process, a target impression is distinguished as either the impression of a tally seal or another type of impression. The impression of a tally seal is excluded from the candidates of the impression of a company seal.

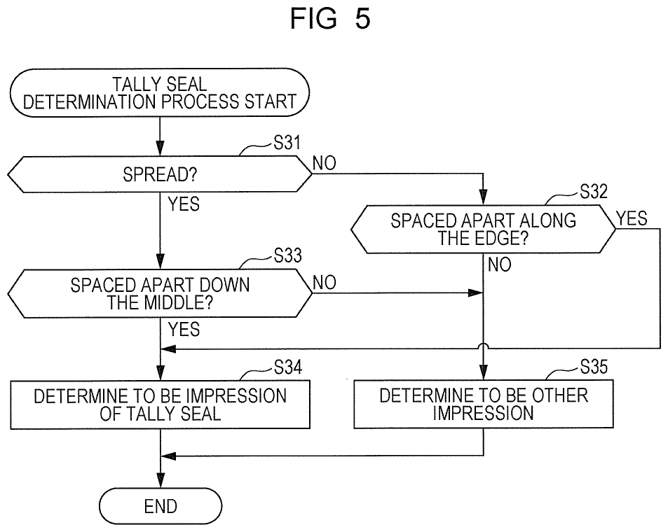

FIG. 5 is a flowchart illustrating an example of the tally seal determination process. In step S31, the processor 11 determines whether or not the document image illustrates spread pages. The determination is made according to the aspect ratio of the document image, for example. In the example illustrated in FIG. 2, the aspect ratio of the document image 20 is a portrait orientation, and therefore the document image is determined not to illustrate spread pages (NO in the determination of step S31). In this case, the flow proceeds to the process of step S32.

In step S32, the processor 11 determines whether or not an impression is provided at an interval from an edge of the document image. In the example illustrated in FIG. 2, the impressions 21 and 22 are provided at an interval from the edge in the −x axis direction of the document image 20 (YES in the determination of step S32). In this case, in step S34, the processor 11 determines that the impressions 21 and 22 are the impressions of tally seals. On the other hand, in the example illustrated in FIG. 2, the impressions 23 to 25 and the noise image 26 included in the document image 20 are not provided at an interval from an edge of the document image 20 (NO in the determination of step S32). In this case, in step S35, the processor 11 determines that the impressions 23 to 25 and the noise image 26 are other types of impressions and not the impressions of tally seals.

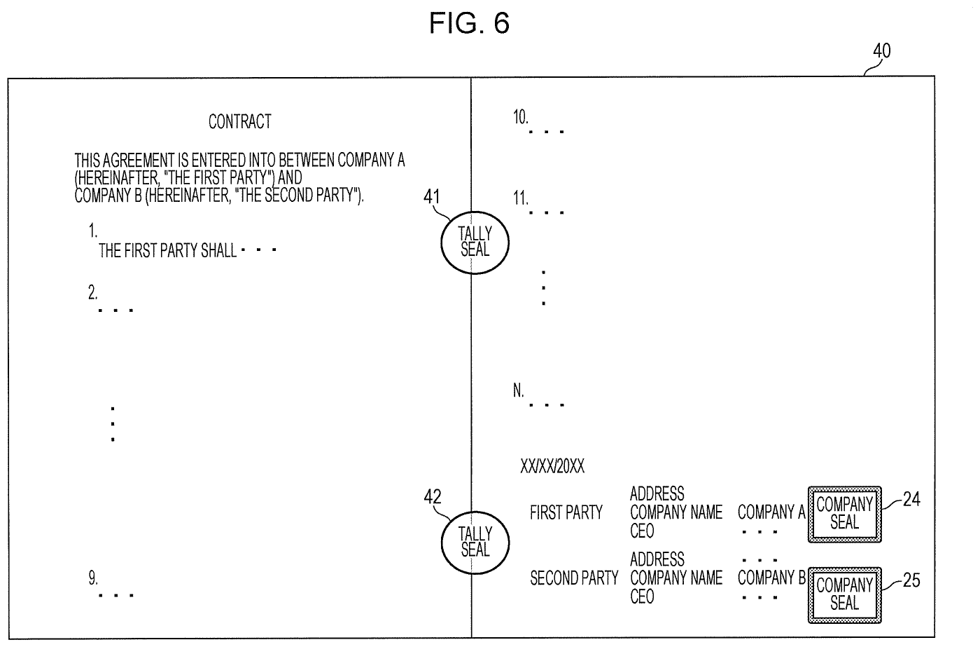

FIG. 6 is a diagram illustrating an example of a different document image 40. The aspect ratio of the document image 40 is a landscape orientation, and therefore the document image is determined to illustrate spread pages in step S31 described above (YES in the determination of step S31). In this case, the flow proceeds to the process of step S33.

In step S33, the processor 11 determines whether or not an impression is provided at an interval apart from the middle of the document image. In the example illustrated in FIG. 6, impressions 41 and 42 are provided at an interval from the middle of the document image 40 (YES in the determination of step S33). In this case, in step S34, the processor 11 determines that the impressions 41 and 42 are the impressions of tally seals. On the other hand, in the example illustrated in FIG. 6, the impressions 24 and 25 included in the document image 40 are not provided at an interval from the middle of the document image 40 (NO in the determination of step S33). In this case, in step S35, the processor 11 determines that the impressions 24 and 25 are other types of impressions and not the impressions of tally seals.

Returning to FIG. 4, in step S22, the processor 11 performs a revision seal determination process. The revision seal determination process is performed on each impression other than the impressions determined to be the impressions of tally seals in step S21 among the impressions detected in step S12. In the revision seal determination process, a target impression is distinguished as either the impression of a revision seal or another type of impression. The impression of a revision seal is excluded from the candidates of the impression of a company seal.

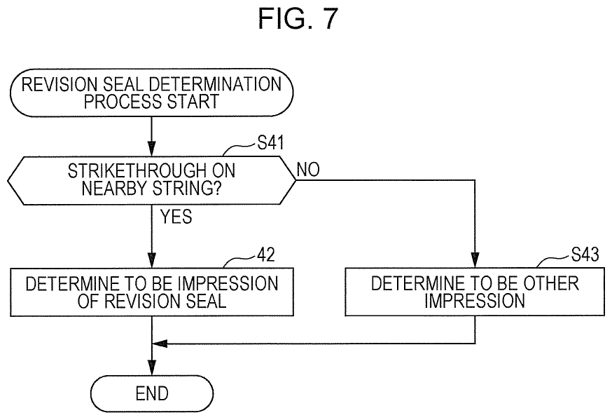

FIG. 7 is a flowchart illustrating an example of the revision seal determination process. In step S41, the processor 11 determines whether or not strikethrough is applied to a character string near the impression. Here, “near” refers to a range inside a predetermined distance centered on the position of the impression for example. In the example illustrated in FIG. 2, the characters “ABC” are stated near the impression 23, and the strikethrough line 27 is applied to the characters (YES in the determination of step S41). In this case, in step S42, the processor 11 determines that the impression 23 is the impression of a revision seal. On the other hand, in the example illustrated in FIG. 2, for the impressions 24 and 25 and the noise image 26 included in the document image 20, there is no character string nearby, or strikethrough is not applied to a nearby character string (NO in the determination of step S41). In this case, in step S43, the processor 11 determines that the impressions 24 and 25 and the noise image 26 are other types of impressions and not the impressions of a revision seal. The other types of impressions are impressions other than the impression of a tally seal and the impression of a revision seal from among the impressions detected from the document image, and therefore are candidates of the impression of a company seal.

Returning to FIG. 4, in step S23, the processor 11 ranks the candidates of the impression of a company seal according to the size of the impression. The larger the impression, the higher the rank assigned. In the case where impressions have the same size, the impression detected earlier is assigned a higher rank. Here, it is assumed that an impression farther in the −y axis direction in the document image is detected earlier. In the example illustrated in FIG. 2, the impressions 24 and 25 are larger than the noise image 26. Consequently, the noise image 26 is assigned a rank of 3. Meanwhile, the impressions 24 and 25 are roughly the same size, but the impression 24 is positioned in the −y axis direction from the impression 25 in the document image 20. Consequently, the impression 24 is assigned a rank of 1 and the impression 25 is assigned a rank of 2.

In step S24, the processor 11 ranks the candidates of the impression of a company seal according to the layout. First, the amount of whitespace surrounding an impression is counted. For example, the number of pixels having the same color as the background is used as the amount of whitespace. Here, “surrounding” refers to a range inside a predetermined distance centered on the impression for example. The greater the amount of surrounding whitespace, the higher the rank assigned. In the case where impressions have the same amount of surrounding whitespace, the impression detected earlier is assigned a higher rank. Here, it is assumed that an impression farther in the −y axis direction in the document image is detected earlier. In the example illustrated in FIG. 2, the impression 24 and 25 are provided in the signature field at the end of the contract. The signature field has more whitespace than other portions of the contract. On the other hand, the noise image 26 is provided among the body text of the contract. The body text of the contract has little whitespace. For this reason, the amount of whitespace surrounding the impressions 24 and 25 is greater than the amount of whitespace surrounding the noise image 26. Consequently, the noise image 26 is assigned a rank of 3. Meanwhile, the impressions 24 and 25 have roughly the same amounts of whitespace, but the impression 24 is positioned in the −y axis direction from the impression 25 in the document image 20. Consequently, the impression 24 is assigned a rank of 1 and the impression 25 is assigned a rank of 2.

In step S25, the processor 11 determines the impressions of company seals according to the ranking. For example, in the case where the number of values to extract is 2, the two highest-ranking impressions are determined to be impressions of company seals. In the example illustrated in FIG. 2, the impression 24 is assigned a rank of 1, the impression 25 is assigned a rank of 2, and the noise image 26 is assigned a rank of 3. Consequently, the impression 24 and the impression 25 are determined to be impressions of company seals.

Returning to FIG. 3, in step S14, the processor 11 recognizes characters included in the document image acquired in step S11. For the character recognition, optical character recognition (OCR) is used for example.

In step S15, the processor 11 extracts a value with respect to a key from the surrounding range of each impression determined to be the impression of a company seal in step S25 in the document image. The surrounding range refers to a predetermined region set with reference to the position of the impression. In the example illustrated in FIG. 2, surrounding ranges 28 and 29 are set with reference to the positions of the impressions 24 and 25. The surrounding ranges 28 and 29 are for example ranges inside a first distance in the −x direction and also inside a second distance in the −y direction from the positions of the impressions 24 and 25, respectively. Herein, the key “company name” is assumed to be determined in advance.

In this case, first, the surrounding range 28 is searched for the key “company name”. Here, in the example illustrated in FIG. 2, because the surrounding range 28 contains the character string 31 stating “Company Name” and the character string 33 stating “Company Name”, these character strings 31 and 33 are detected as keys as a result of the search. In this case, the character string 31 closest to the position of the impression 24 is used, and the character string 33 is not used. Additionally, a value is extracted from a nearby range of the character string 31. The nearby range refers to a predetermined region set with reference to the position of the character region 31. The nearby range is smaller than the surrounding range, for example. Herein, the nearby range is the range inside a predetermined distance in the x axis direction from the position of the character string 31. Note that in the case where the format of the value is predetermined, information in the predetermined format among the information included in the nearby range is extracted as the value. In the example illustrated in FIG. 2, the character string 32 stating “Company A” in the nearby range of the character string 31 is extracted as the value with respect to the character string 31. The character strings 31 and 32 are both results of character recognition. Note that at this point, the character string 34 stating “Company B” in the nearby range of the character string 33 is not extracted. In other words, only the value closest to the position of the impression 24 is extracted.

Next, the surrounding range 29 is searched for the key “company name”. In the example illustrated in FIG. 2, because the surrounding range 29 contains only the character string 33 stating “Company Name”, the character string 33 is detected as a key as a result of the search. Additionally, the character string 34 stating “Company B” in the nearby range of the character string 33 is extracted as the value with respect to the character string 33. The character strings 33 and 34 are both results of character recognition.

The values extracted in step S15 are paired with the corresponding keys and stored in the storage unit 14, for example. In the example illustrated in FIG. 2, the pair of the character string 31 stating “Company Name” and the character string 32 stating “Company A”, and the pair of the character string 33 stating “Company Name” and the character string 34 stating “Company B”, are stored in the storage unit 14. Also, these pairs of a key and a value may be added to the document image 20 as attribute information.

According to the exemplary embodiment described above, information indicating the parties to a contract is extracted from the surrounding ranges of the impressions of company seals, and therefore the information indicating the parties to the contract may be extracted more accurately compared to the case of extracting information indicating the parties to a contract irrespectively of the positions of the impressions of company seals. Also, because a value is extracted from inside the surrounding range of the impression of a company seal, the processing load for extracting the value is decreased compared to the case of treating the entire document image as the range from which to extract a value. Furthermore, because the impression of a tally seal and the impression of a revision seal included in the document image are excluded from the candidates of the impression of a company seal, in the case where the document image contains an impression of a tally seal and the impression of a revision seal, it is possible to avoid a situation in which these impressions are used as the impressions of company seals, and incorrect information is extracted as a value. In other words, in the case where the document image contains an impression of a tally seal and the impression of a revision seal, it is possible to avoid a situation in which the accuracy of extracting information about the parties to a contract is lowered.

Furthermore, because the impressions of tally seals are determined by the position and spacing of the impressions in the document image, these impressions may be distinguished more accurately compared to the case of distinguishing the impressions of tally seals from other types of impressions irrespectively of the position and spacing of the impressions in the document image. Furthermore, in the case where the document image illustrates a single page, impressions provided along an edge of the document image are determined to be impressions of tally seals, and therefore these impressions may be distinguished more accurately compared to the case of distinguishing the impressions of tally seals from other types of impressions irrespectively of the position at the edge of the document image in this case. Furthermore, in the case where the document image illustrates spread pages, impressions provided at the boundary between the pages are determined to be impressions of tally seals, and therefore these impressions may be distinguished more accurately compared to the case of distinguishing the impressions of tally seals from other types of impressions irrespectively of the position at the boundary between the pages in this case.

Furthermore, because impressions at position corresponding to characters with strikethrough applied in the document image are determined to be the impressions of revision seals, these impressions may be distinguished more accurately compared to the case of distinguishing the impressions of revision seals from other types of impressions irrespectively of the position corresponding to characters with strikethrough applied in the document image. Furthermore, because the impressions of company seals are determined in accordance with a ranking assigned according to the sizes of the impressions, these impressions may be distinguished more accurately compared to the case distinguishing the impressions of company seals from other types of impressions irrespectively of the sizes of the impressions. Furthermore, because the impressions of company seals are determined in accordance with a ranking assigned according to the amounts of whitespace surrounding the impressions, these impressions may be distinguished more accurately compared to the case distinguishing the impressions of company seals from other types of impressions irrespectively of the amounts of whitespace surrounding the impressions. Furthermore, in the case where a surrounding range of an impression of a company seal contains information indicating multiple parties to a contract, only the information indicating a party to the contract closest to the position of the impression of the company seal is extracted, and therefore the information indicating the parties to the contract may be extracted more accurately compared to the case of extracting information indicating the parties to the contract irrespectively of the position of the information with respect to the impression of a company seal.

### 3. Exemplary Modifications

The exemplary embodiment described above is one example of the present disclosure. The present disclosure is not limited to the exemplary embodiment described above. In addition, the exemplary embodiment described may also be modified like the following examples. At this time, two or more of the following exemplary modifications may also be combined and used.

In the exemplary embodiment described above, after impressions are detected, the processor 11 may also remove the impressions from the document image and perform character recognition on the document image with the impressions removed. The removal of impressions may be performed using existing technology. For example, vermilion portions that are the color of an impression may be removed from the document image. In the example illustrated in FIG. 2, the impressions 24 and 25 of company seals are overlapping the last characters of the character strings 32 and 34 stating “Company A” and “Company B”, respectively. By performing character recognition after removing the impressions 24 and 25 of the company seals, the character strings 32 and 34 may be recognized more accurately. According to this exemplary modification, the accuracy of character recognition is improved compared to the case of performing character recognition before removing impressions.

In the exemplary embodiment described above, the processor 11 may also change the surrounding range of an impression of a company seal. For example, the surrounding range of an impression of a company seal may be changed depending on the type of document. This is because in some cases, the positional relationship between an impression of a company seal, a key, and a value is different depending on the type of document. For example, in the case where the type of document is a first type, the length of the surrounding range in the vertical direction or the horizontal direction may be changed such that the surrounding range is a horizontally long shape. On the other hand, in the case where the type of document is a second type, the length of the surrounding range in the vertical direction or the horizontal direction may be changed such that the surrounding range is a vertically long shape. In another example, the surrounding range of an impression of a company seal may be changed depending on the type of value. This is because in some cases, the positional relationship between an impression of a company seal, a key, and a value is different depending on the type of value. For example, the size or shape of the surrounding range may be changed between the case where the value is a company name and the case where the value is a personal name. In another example, the surrounding range of an impression of a company seal may be changed depending on the position of the impression of the company seal. In the example illustrated in FIG. 2, the surrounding ranges 28 and 29 may be changed such that the bottom edge of the surrounding range 28 and the top edge of the surrounding edge 29 are positioned between the impression 24 of a company seal and the impression 25 of a company seal, such as positioned midway, for example. Alternatively, in the example illustrated in FIG. 2, a blank line is provided between the signature field of the first party and the signature field of the second party. Consequently, the surrounding ranges 28 and 29 may be changed such that the bottom edge of the surrounding range 28 and the top edge of the surrounding range 29 are positioned on the blank line. With this arrangement, the extraction of multiple values from the single surrounding range 29 is avoided.

In the exemplary embodiment described above, the method of determining whether or not a document image illustrates spread pages is not limited to a method using the aspect ratio. For example, in the case where the user performs an operation of designating whether or not the pages are spread pages, the determination of whether or not the document image illustrates spread pages may be made according to the operation. In another example, because a line or a dashed line is provided in the middle of a spread page layout in some cases, the determination of whether or not the document image illustrates spread pages may be made according to the presence or absence of such a line. In another example, depending on the document, the first page and the last page may be a single page that serves as the front and back covers while all other pages are spread pages in some cases, and therefore the determination of whether or not the document image illustrates spread pages may be made according to whether the page is the first page or the last page.

In the exemplary embodiment described above, the tally seal determination process and the revision seal determination process may also be performed after assigning a ranking. In this case, impressions of tally seals and impressions of revision seals may also be ranked. Also, impressions having a size that is less than a threshold may be excluded from the candidates of an impression of a company seal, whereas impressions having a size that is the threshold or greater may be assigned a rank according to the layout.

In the exemplary embodiment described above, in the case where the rank according to size and the rank according to layout are different, the rank according to size may be changed by the rank according to layout. For example, in the case where the rank according to size is 2 and the rank according to layout is 3, the rank may be lowered to 3. Also, a score may be computed on the basis of the rank according to size and the rank according to layout, and a combined rank may be computed according to the score. For example, in the case where the rank according to size is 1 and the rank according to layout is 1, the score is 1+1=2. In the case where the rank according to size is 2 and the rank according to layout is 2, the score is 2+2=4. In the case where the rank according to size is 3 and the rank according to layout is 3, the score is 3+3=6. In this case, the combined rank is high in order of lowest score.

In the exemplary embodiment described above, a rank does not necessarily have to be assigned. For example, in the case where only an impression of a company seal, an impression of a tally seal, and an impression of a revision seal are detected from the document image, ranks do not have to be assigned. In this case, the impression that is neither an impression of a tally seal nor the impression of a revision seal from among the impressions detected from the document image is the impression of a company seal.

In the exemplary embodiment described above, the tally seal determination process and the revision seal determination process do not necessarily have to be performed. Generally, an impression of a company seal is larger than other types of impressions, such as an impression of a tally seal of an impression of a revision seal, and therefore the impression of a company seal is assigned a higher rank according to size than other types of impressions. Consequently, the impression of a company seal may be determined by the rank according to size. Also, generally, the impression of a company seal has more surrounding whitespace than other types of impressions, and therefore even if another type of impression is as large as or larger than the impression of a company seal, the impression of a company seal is assigned a higher rank according to layout than other types of impressions. Consequently, the impression of a company seal may be determined by the rank according to layout in addition to the rank according to size.

In the exemplary embodiment described above, an impression of a company seal may be used as a key. In this case, a value may be extracted from the nearby range of the key. The nearby range refers to a predetermined region set with reference to the position of the impression of a company seal. In the example illustrated in FIG. 2, the company name of the first party to the contract and the company name of the second party to the contract are stated in the range inside a predetermined distance in the −x axis direction from the positions of the impressions 24 and 25 of company seals. In this case, the nearby range may be the range inside a predetermined distance in the −x axis direction from the positions of the impressions 24 and 25 of company seals. In this case, the character string “Company Name” does not have to be set as a key. A value may be extracted even with such a method.

In the exemplary embodiment described above, character recognition does not necessarily have to be performed on the entire document image. For example, character recognition may be performed only in the surrounding range of the impression of company seal.

In the exemplary embodiment described above, the specific type of impression is not limited to the impression of a company seal. For example, in the case where the parties to a contract are individuals, the personal seals of the individuals may be impressed beside the names of the contracting parties in some cases. In this case, the specific type of impression is the impression of a personal seal of an individual. The impression of a personal seal of an individual is assigned a lower rank according to size, but is assigned a higher rank according to layout, and therefore may be determined to be the specific type of impression.

In the exemplary embodiment described above, the document illustrated by the document image is not limited to a contract. The document may any type of document insofar as the document contains a value stated near an impression, such as a receipt or an invoice, for example. Additionally, the value is not limited to information indicating a party to a contract. For example, the value may be any type of information that is stated near an impression, such as the issuer of a receipt or an invoice.

In the exemplary embodiment described above, some of the functions of the image processing device 10 may also be provided in an external device. For example, a server device connected to the image processing device 10 through a communication channel may acquire a document image from the image processing device 10 and perform the process of extracting a value from the document image. In this example, the server device is the information processing device according to an exemplary embodiment of the present disclosure.

In the exemplary embodiment above, the term “processor” refers to hardware in a broad sense. Examples of the processor include general processors (e.g., CPU: Central Processing Unit), and dedicated processors (e.g., GPU: Graphics Processing Unit, ASIC: Application Integrated Circuit, FPGA: Field Programmable Gate Array, and programmable logic device).

In the embodiment above, the term “processor” is broad enough to encompass one processor or plural processors in collaboration which are located physically apart from each other but may work cooperatively. The order of operations of the processor is not limited to one described in the embodiment above, and may be changed.

An exemplary embodiment of the present disclosure may also be provided as a program executed in the image processing device 10. The image processing device 10 is an example of a computer according to an exemplary embodiment of the present disclosure. The program may be downloaded through a communication channel such as the Internet, or may be provided by being recorded onto a computer readable recording medium such as a magnetic recording medium (such as magnetic tape or a magnetic disk), an optical recording medium (such as an optical disc), a magneto-optical recording medium, or semiconductor memory.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing device comprising:
a processor configured to
acquire a document image illustrating a document, and
extract target information with respect to a target character string from a region set with reference to a position of a specific type of impression included in the document image.

2. The information processing device according to claim 1, wherein
the processor is configured to use an impression other than a first type of impression and a second type of impression among a plurality of impressions included in the document image as the specific type of impression.

3. The information processing device according to claim 2, wherein
the first type of impression is provided at an interval from a predetermined position in the document image.

4. The information processing device according to claim 3, wherein
the predetermined position is an edge of the document image in a case where the document image illustrates a single page included in the document.

5. The information processing device according to claim 3, wherein
the predetermined position is a boundary between a plurality of pages in the document image in a case where the document image illustrates a plurality of pages included in the document.

6. The information processing device according to claim 2, wherein
the second type of impression is provided at a position corresponding to a character with strikethrough applied that is included in the document image.

7. The information processing device according to claim 1, wherein
the specific type of impression is larger than another impression included in the document image.

8. The information processing device according to claim 2, wherein
the specific type of impression is larger than another impression included in the document image.

9. The information processing device according to claim 7, wherein
the specific type of impression has a greater amount of surrounding whitespace than another impression included in the document image.

10. The information processing device according to claim 8, wherein
the specific type of impression has a greater amount of surrounding whitespace than another impression included in the document image.

11. The information processing device according to claim 1, wherein
in a case where a plurality of target information with respect to the target character string is included in the region, the processor is configured to
extract the target information closest to the position from among the plurality of target information.

12. The information processing device according to claim 1, wherein
the processor is configured to
detect at least one impression, including the specific type of impression, from the document image, and
perform character recognition on the document image after detecting the at least one impression, and
the target information is a result of the character recognition.

13. The information processing device according to claim 12, wherein
the processor is configured to
remove the specific type of impression detected from the document image, and
perform the character recognition on the document image from which the specific type of impression has been removed.

14. A non-transitory computer readable medium storing a program causing a computer to execute a process for processing information, the process comprising:
acquiring a document image illustrating a document; and
extracting target information with respect to a target character string from a region set with reference to a position of a specific type of impression included in the document image.

15. An information processing device comprising:
acquiring means for acquiring a document image illustrating a document; and
extracting means for extracting target information with respect to a target character string from a region set with reference to a position of a specific type of impression included in the document image.
